(19) United States
(12) Patent Application Publication
(10) Pub. No.: US 2014/0183831 A1
(43) Pub. Date: Jul. 3, 2014

(54) WALKING AID DEVICE WITH FOLDABLE SEAT

(71) Applicants: Zulkifli Bin Mohd Din, Singapore (SG); Chow Toon Keh, Singapore (SG); Hock Lai Ng, Singapore (SG)

(72) Inventors: Zulkifli Bin Mohd Din, Singapore (SG); Chow Toon Keh, Singapore (SG); Hock Lai Ng, Singapore (SG)

(73) Assignee: Nanyang Polytechnic, Singapore (SG)

(21) Appl. No.: 14/131,092

(22) PCT Filed: Jul. 4, 2011
(86) PCT No.: PCT/SG2011/000235

§ 371 Date: Mar. 12, 2014

(51) Int. Cl. A61H 3/04; A61H 3/00

(52) U.S. Cl. CPC A61H 3/04; A61H 3/00
USPC 280/30; 297/195.11; 135/66

(57) ABSTRACT

A foldable seat for a walking aid. The foldable seat includes a rigidly affixed leg for added stability. The foldable seat is further configured to move from a use position in a support area of the walking aid to a storage area that minimizes the interference of the foldable seat with a user in the support area. The foldable seat moves in such a manner that the seat remains substantially parallel to the ground.

### FIELD OF THE INVENTION

This invention relates to a foldable seat for a walking aid device. More particularly, this invention relates to a foldable seat for a rollator. Still more particularly, this invention relates to a foldable seat for a rollator that provides rigid support and structural changes to a rollator to increase support.

### PRIOR ART

It is known that the elderly and infirm often need assistance to walk. The art is filled with many different types of walking aids. One particular type of walking aid is a rollator. Rollators typically have four support legs that are configured such that a quadrilateral base is formed from four support legs. A user then uses handles to walk in a defined support area either behind or in the middle of the base.

The provision of a seat for a rollator has been proposed by others skilled in the art to allow a user to rest without having to find a seat. However, most of these designs are problematic. A first type of proposed seat is built integrated into the base of the rollator. Designs for these types of seats are described in U.S. Pat. No. 6,659,478 issued to Hallgrimsson et al. issued 9 Dec. 2003 and US Patent Publication 2009/0033052 in the name of Bradshaw et al. published 5 Feb. 2009. The problem with these types of design is that the user must turn around and back into the seat often without support from the walking aid. This may be problematic for the elderly and infirm that are reliant on the walking aid for support.

To overcome the above problem, others have proposed providing a folding seat that allows the seat to be located in the support area of the walking aid to allow a user to use the aid for support while attempting to sit on the seat. This type of seat typically must be foldable such that the seat can be stored in a place that does not interfere with the support area to prevent the hampering of the user's movement while walking. Japanese Patent Publication 20050314923 in the name of OG Giken Co. Ltd. published 17 May 2007 and Japanese Patent Publication 20030189423 in the name of OG Giken Co. Ltd. published 27 Jan. 2005 provide two examples of such foldable seats configured for rollators. In these publications, the described seat is affixed to the rollator by two moving bars that are affixed to supports that form a base of the rollator. In these described embodiments there is no support under the sitting surface. Thus, the seat may be unstable in use which may lead to accidents when an elderly or infirm user uses the seat. To rectify this problem, these publications also propose adding a piston that is connected to the bottom of the seat and to the support to which the moving bars are connected. Thus, the support is not directly underneath the disclosed folding seats which may still make these seats unstable during use.

To provide better stability others have proposed providing foldable seats with foldable legs. Typically the legs must be foldable to prevent the legs from extending into the support area when the seat is folded in the stored position. An example of this type of foldable seat is described in US patent publication 2010/023697 in the name of Catton published 21 Oct. 2010. The problem with this solution is the foldable leg may be difficult for an infirm person to operate. Further, if the leg is not unfolded properly, the seat may remain unstable or cause injury to the user.

For these reasons and more, those skilled in the art are constantly striving to improve the designs of foldable seats for use with walking aids.

### SUMMARY OF THE INVENTION

The above and other problems are solved and an advance in the art is made by a folding seat for a walking aid in accordance with this invention. One advantage of a foldable seat in accordance with this invention is that a leg that is rigidly attached to the bottom of the seat is provided to provide better stability for the seat when in use. A second advantage of a foldable seat in accordance with this invention is that the seat moves between the stored and use positions in the same configuration as when the seat is in use. Thus, the amount of manipulation required to move the seat between stored and used positions is minimized. A third advantage of a foldable seat in accordance with this invention is that the seat is always within the field of vision of the user. Thus, the risk of a misstep when the user moves forward to mount the seat is reduced. A fourth advantage of a foldable seat in accordance with this invention is that the user may hold onto the support handles at all times while mounting the seat. Thus, the risk of the rollator and/or seat moving when being mounted is reduced. A fifth advantage of a foldable seat in accordance with this invention is that the seat can be secured in the stored position by a locking mechanism. Thus, an open space between the four support legs is provided that allows a user to stand within the rollator frame. The open space allows a tired user to rest while standing without the need to be seated. A sixth advantage of a foldable seat in accordance with this invention is that the seating device can be coupled and de-coupled to most walking aids. Thus, a user can use a type of walking aid that is to his needs.

In accordance with embodiments of this invention, a foldable seat that may be attached to a walking aid is provided. In accordance with particular ones of these embodiments, the walking aid is a rollator. In accordance with some of these embodiments, the rollator is configured in the following manner. Four support legs are arranged such that a quadrilateral support area is formed between the support legs. A first brace bar extends between a first front support leg and a second front support leg.

In accordance with some of these embodiments, the rollator further includes a u-shaped brace that connects a first rear support leg and a second rear support leg. This u-shaped bar may be configured in the following manner. A first end extends from the first rear support leg towards the first front support leg. A second end extends from the second back leg towards the second front support leg. A middle portion then extends between the first and second ends of the u-shaped bar to provide an open area between the four support legs.

In accordance with further of these embodiments, a first support handle is affixed to a support between the first front support leg and the first rear support leg. A second support handle is also affixed to a support between the second front support leg and the second rear support leg. In accordance with some of these embodiments, the first and second support handles are each substantially cylindrical and extend substantially perpendicular to the four support legs.

In accordance with some embodiments of this invention, a table is pivotally mounted to a support between the first front support leg and the second front support leg on an opposite side of the support from the support area. In accordance with further of these embodiments, a basket may be mounted to the support under the table.

Furthermore, in accordance with embodiments of this invention, the rollator includes at least one wheel attached to a bottom end of the first front support and a wheel attached to a bottom end of the second front support. In accordance with some embodiments, wheels may be attached to each of the four support legs.

In accordance with embodiments of this invention, the foldable seat is configured in the following manner. A seat has a top and bottom surface. The top surface provides a seating area. A leg is rigidly affixed to the bottom surface of the seat and extends downward substantially perpendicularly from the bottom surface of the seat surface. A mounting is affixable to the first brace bar of the walking aid device. First and second moving bars are connected between the mounting clamp and the seat. The first moving bar has a first end pivotally connected to the seat proximate a first end of the bottom surface and a second end pivotally connected to the mounting clamp. The second bar has a first end pivotally connected to the seat proximate a first end of the bottom surface and a second end pivotally connected to the mounting clamp. The second bar is configured such that the second moving bar is co-planar and parallel with the first moving bar and is situated between the first moving bar and the ground. This allows the first moving bar and second moving bar to rotate in order to move the seat from a use position in which an end of the leg is in contact with the ground to a stored position in which said leg is substantially parallel with the first and second moving bars while keeping the seat substantially parallel to the ground. The legs are configured in such a manner to support rotation between the stored and use position. In some embodiments, the configuration may include the second moving bar being a greater length than the first bar. In other embodiments, the configuration may include the pivots on the seat and/or mounting clamp being offset from one another.

In accordance with some embodiments, a locking mechanism is provided that holds the leg substantially parallel with the first and second moving bars responsive to the seat being in the second position. The locking mechanism may be a clip, a magnet, or a Velcro strap.

In accordance with some embodiments, a base is affixed to a bottom surface of the seat. The leg is secured to the base and the second ends of first and second moving bars are pivotally affixed to the base.

In accordance with some embodiments of this invention, a connector on the mounting clamp allows the mounting clamp to be coupled and decoupled to and from the support of the walking aid device.

In accordance with some embodiments of this invention, a resistance means for providing constant resistance as the seat is moved between the first and second positions is included. In accordance with some of these embodiments the resistance means is a spring having a first end attached to the mounting clamp and a second end affixed to a point along one of said first and second moving bars. This configuration allows the spring to be in a relaxed state in the first and second positions of the seat and is stretched during movement between the first and second positions. In accordance with others of these embodiments, the resistance means includes a first disk spring assembly and a second disk spring assembly. Each disk spring assembly consists of a bolt and two groupings of one disk spring in-between two flat washers. The groupings of disk spring and flat washers are placed co-axially with the tightening bolt sandwiching the moving bar to provide for constant resistance as the seat is moved between the first and second positions.

In accordance with some embodiments of this invention, supports that extend from a bottom end of the leg to form a base to support the seat.

### BRIEF DESCRIPTION OF THE DRAWINGS

The above and other features and advantages of a walking aid with a foldable seat are described in the following detailed description and are shown in the following drawings:

FIG. 1 illustrating a side view of a rollator with a foldable seat in a deployed position in accordance with embodiments of this invention;

FIG. 2 illustrating a side perspective view of the rollator with a foldable seat in a deployed position in accordance with embodiments of this invention;

FIG. 3 illustrating a rear perspective view of the rollator with a foldable seat in a deployed position in accordance with embodiments of this invention;

FIG. 4 illustrating a second side perspective view of the rollator with a foldable seat in a deployed position in accordance with embodiments of this invention;

FIG. 5 illustrating a rear perspective view of the rollator with a foldable seat in a stored position in accordance with embodiments of this invention;

FIG. 6 illustrating a side perspective view of the rollator with a foldable seat in a stored position in accordance with embodiments of this invention;

FIG. 7 illustrating a side view of the rollator with a foldable seat in a stored position in accordance with embodiments of this invention; and

FIG. 8 illustrating a second rear perspective view of the rollator with a foldable seat in a stored position in accordance with embodiments of this invention.

### DETAILED DESCRIPTION

This invention relates to a foldable seat for a walking aid device. More particularly, this invention relates to a foldable seat for a rollator. Still more particularly, this invention relates to a foldable seat for a rollator that provides rigid support and structural changes to a rollator to increase support.

For purposes of this discussion, a walking aid device is any device that may be used to support a person while walking. In accordance with particular embodiments, a walking aid is a device with two or more support legs that provides a support area behind or between the support legs to allow a person using the device to walk in the support area while holding unto the device for support. In particular ones of these embodiments, a walking device is a rollator which has four support legs with wheels on the bottom of at least the front two support legs to allow a user to roll the device along with the user as the user uses the device for support while walking.

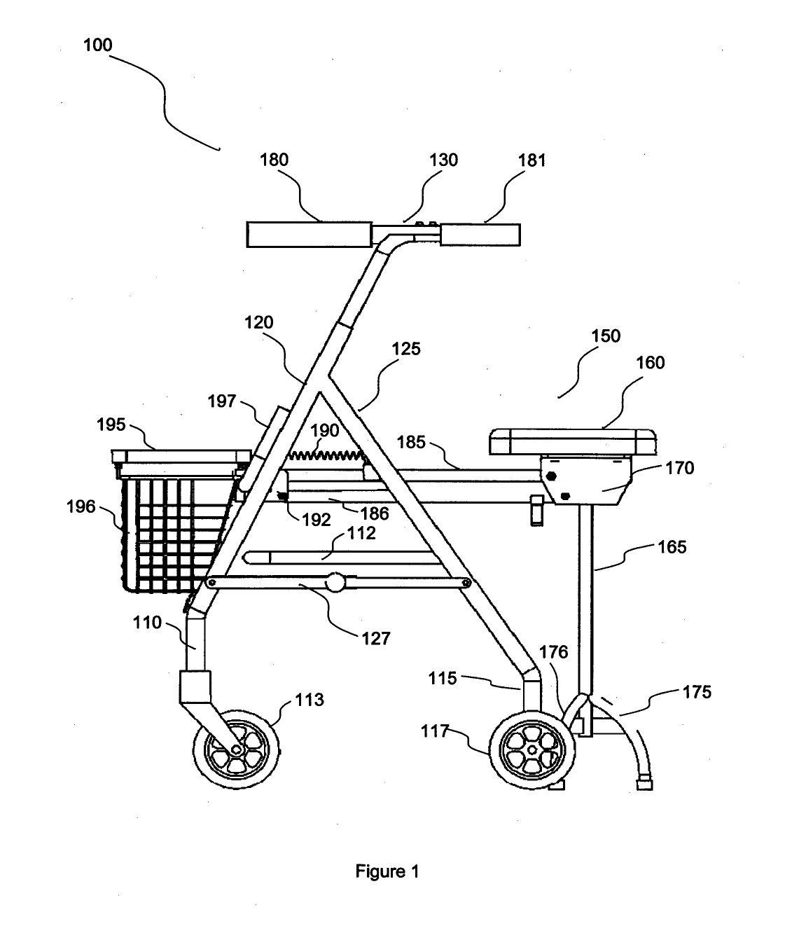

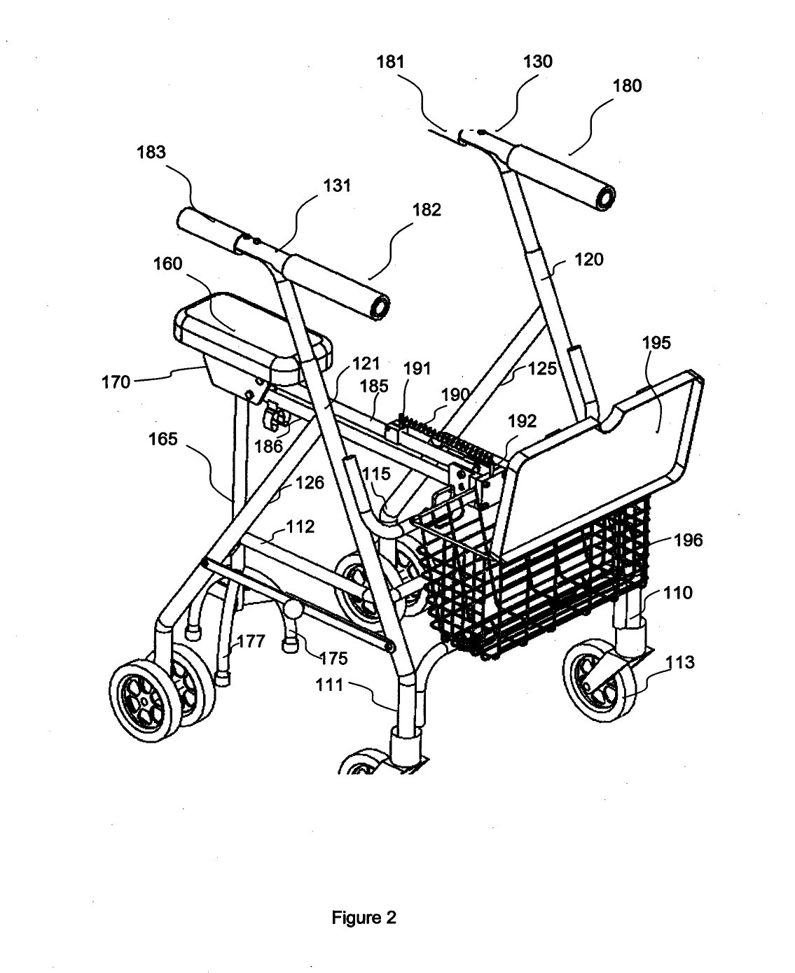

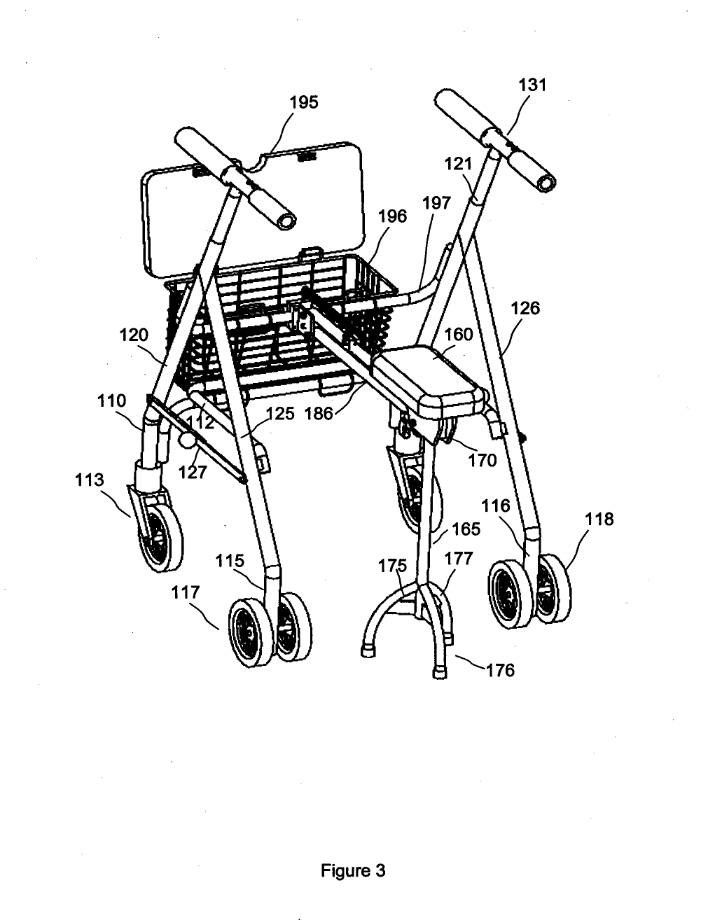

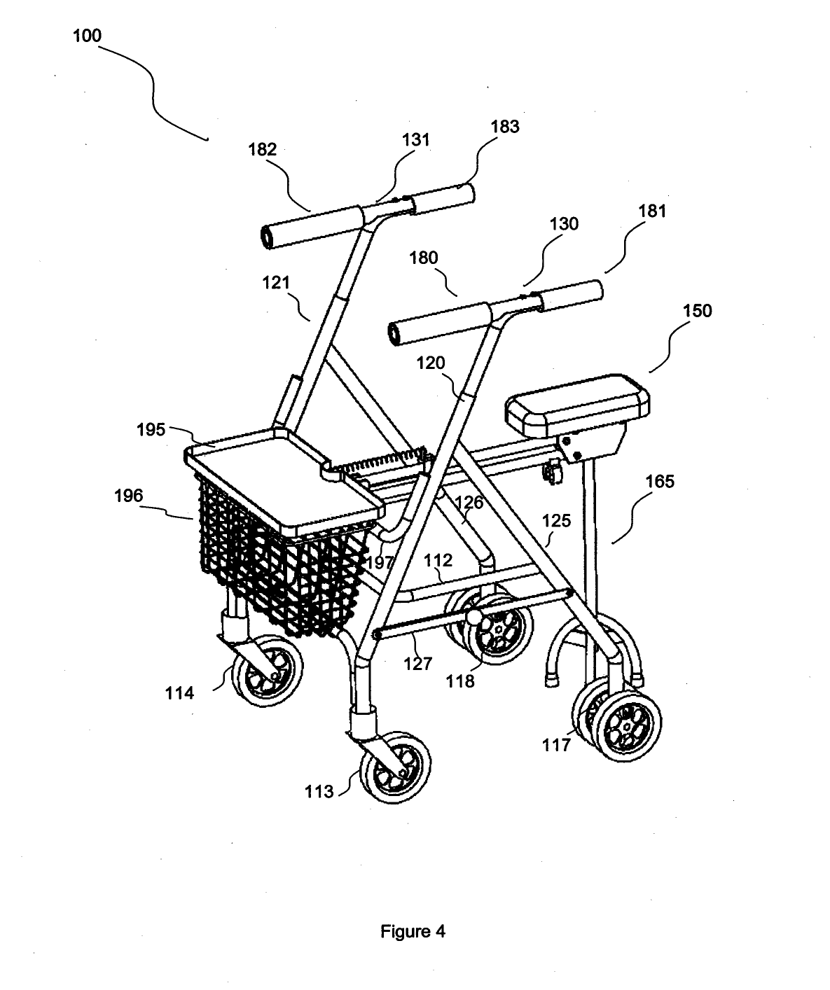

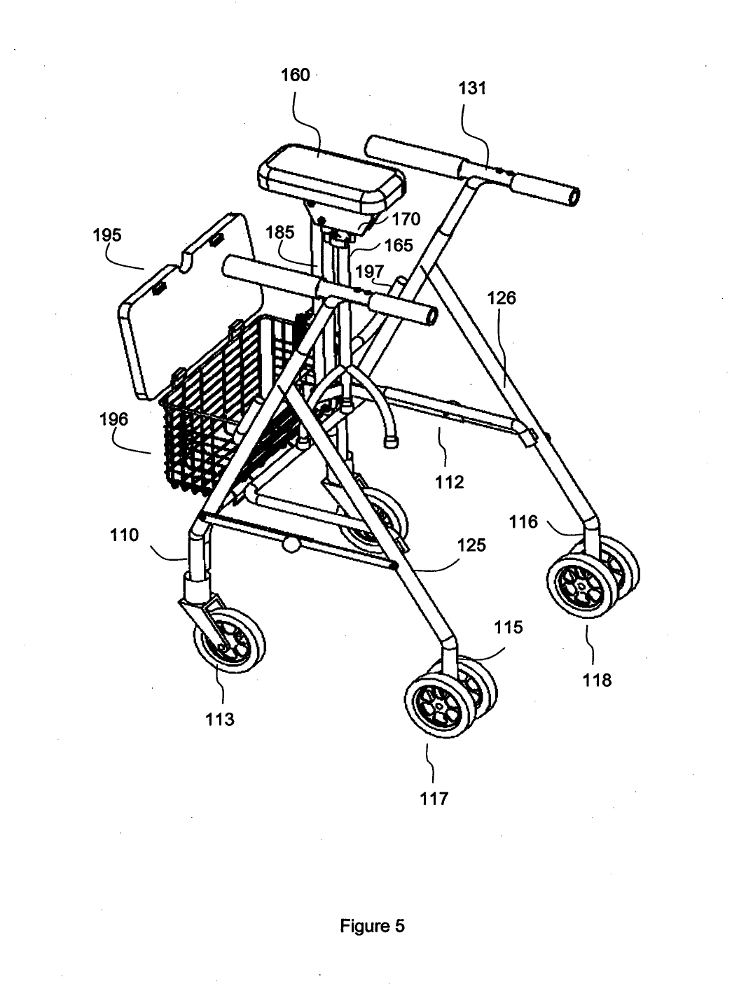

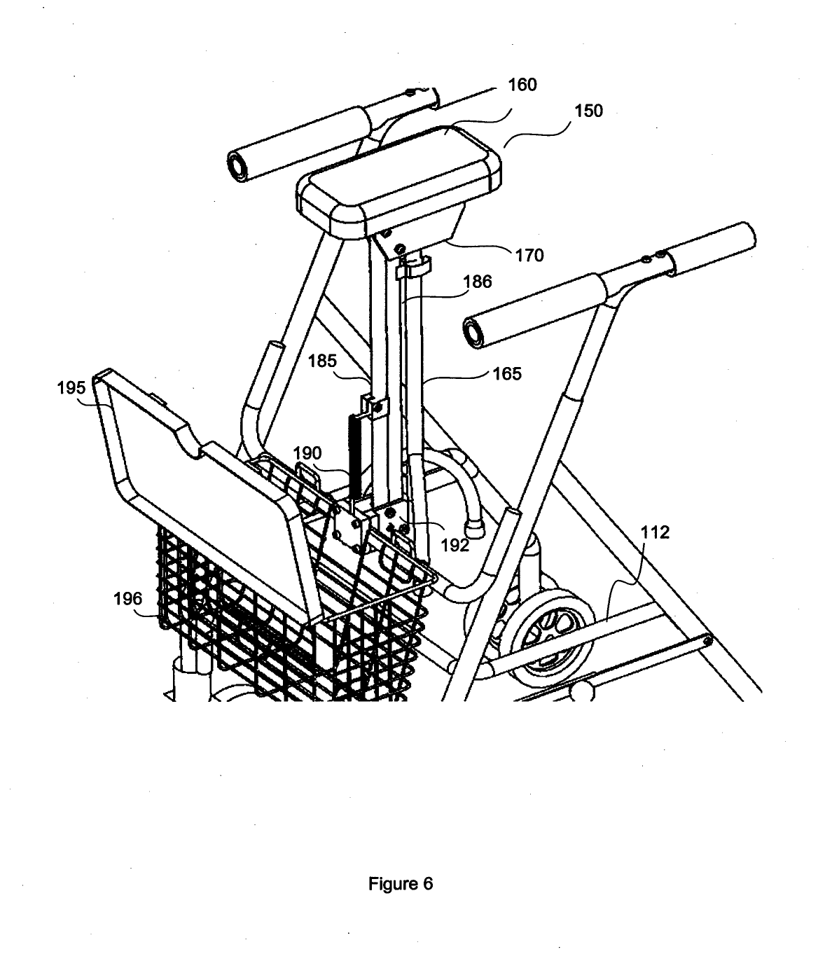

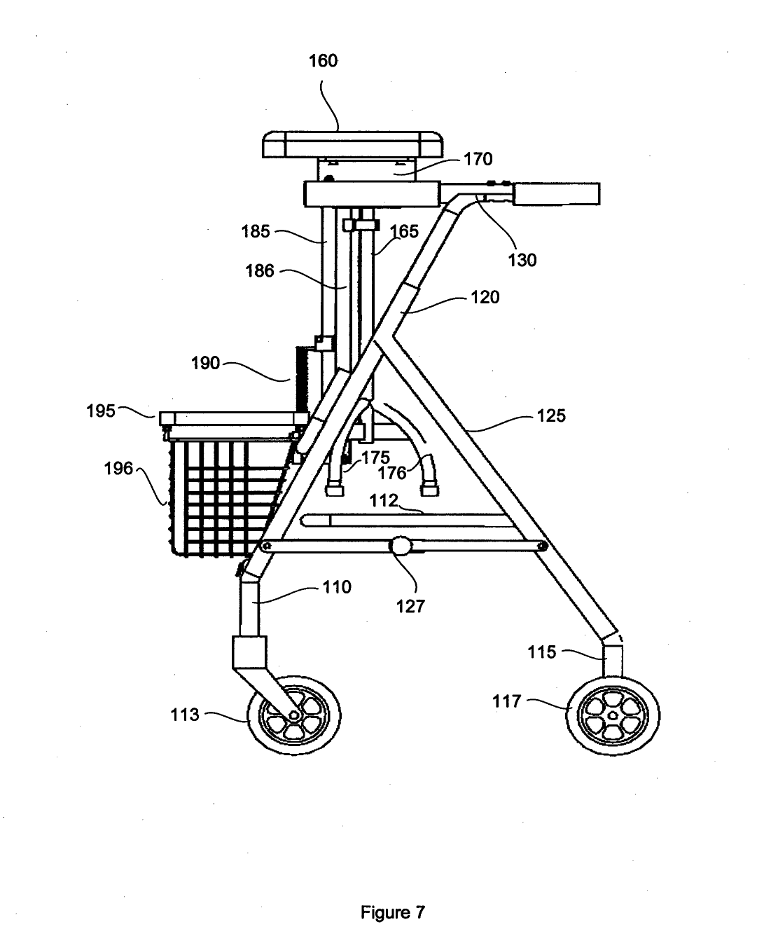

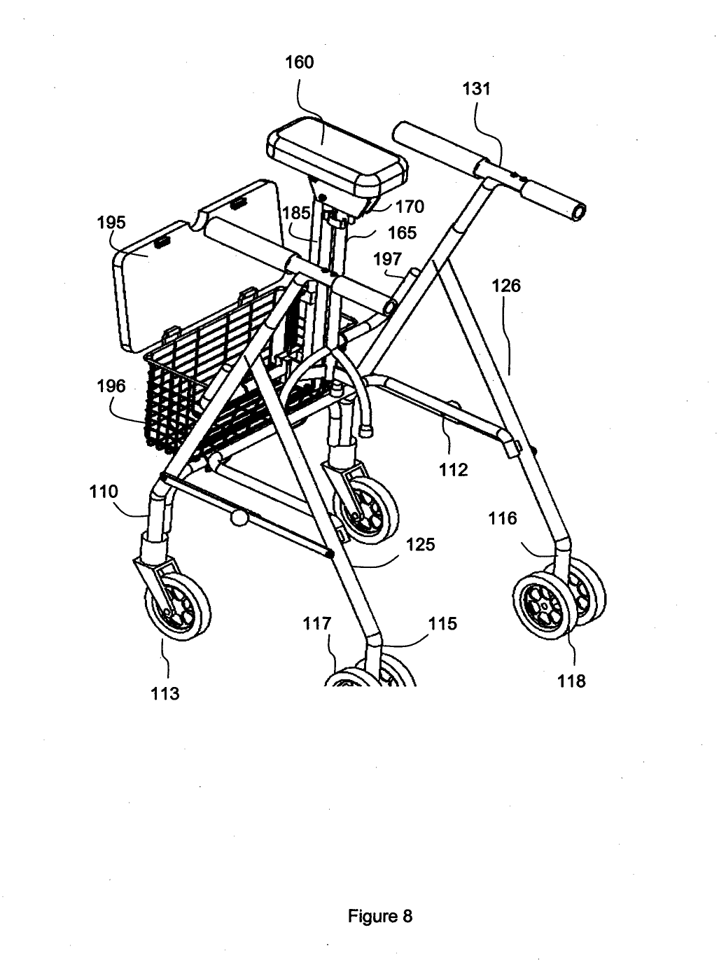

FIGS. 1-8 illustrate various views of rollator 100 with a foldable seat in accordance with this invention. Rollator 100 includes added features that improve rollator 100 to provide added stability. Thus, the added features aid in providing stability when the foldable seat is used by an infirm person to rest. However, these added features are not necessary for incorporation of the foldable seat into rollator 100. Rollator 100 includes first front support leg 120 and second front support leg 121. In the shown embodiment, first front support leg 120 and second front support leg 121 extend at approximately a 60 degree angle to the ground and have bottom ends 110 and 111 that extend approximately perpendicular to the ground when in a use configuration. One skilled in the art will recognize the first front support leg 120, second front support leg 121, and bottom ends 110-111 may extend at any angles when in use without departing from this invention. Handle 130 is affixed to a top end of first front support leg 120 and handle 131 is affixed to a top end of second front support leg 121. Handles 130 and 131 extend approximately parallel to the ground and may include grip coverings 180-183. Grip coverings are coverings that surround handles 130-131 to provide a material that facilitates the grip of the user. The material used for the covering may be soft malleable material to provide comfort when gripping or a tactile material to provide for a better gripping surface without departing from this invention. Preferably, handle bars are connected to first and second front support legs 120 and 121 in manner that facilitates use when a user is inside a support between front support legs 120-121 and rear support legs 125-126. However, one skilled in the art will recognize that other configurations may be used without departing from this invention.

First rear support leg 125 has a first end affixed to first front support 120. Preferably, first rear support leg 125 is affixed by a hinge, pivot or other type of connection that allows first rear support leg 125 to move from a stored position in which first rear support leg 125 is substantially parallel to first front support leg 120 to a use position in which first rear support leg 125 is extends out at angle with respect to first front support leg 120. A second end 115 of first rear support leg 125 has wheel 117 attached. In the shown embodiment, second end 115 includes a portion that extends substantially perpendicular to the ground from a bend in first rear support leg 125. One skilled in the art will recognize that the exact configuration of each rear support leg and the relation between the configuration of the front and rear support legs is a design choice left to those skilled in the art.

Second rear support leg 126 has a first end affixed to second front support leg 121. Preferably, second rear support leg 126 is affixed by a hinge, pivot or other type of connection that allows second rear support leg 126 to move from a stored position in which second rear support leg 126 is substantially parallel to second front support leg 121 to a use position in which second rear support leg 126 is extends out at angle with respect to second front support leg 121. A second end 116 of second rear support leg 126 has wheel 118 attached. In the shown embodiment, second end 116 includes a portion that extends substantially perpendicular to the ground from a bend in second rear support leg 126. One skilled in the art will recognize that the exact configuration of each rear support leg is a design choice of those skilled in the art. In accordance with some embodiments of this invention, a configuration of the support legs is such that each of the wheel is at a corner of a quadrilateral formed by the second end of the supports legs to allow a support area to be provided in the quadrilateral such that a center of gravity of a user is between the wheels.

First front support leg 120 and first rear support leg 125 are connected by first folding bar 127. First folding bar 127 is made of two portions. Each of the portions of first folding bar 127 has a first end connected to one of first front support leg 120 or first rear support leg 125 by a pivot; and the second ends of the portions are connected by a pivot or a hinge to allow the portions of the folding bars to move between a stored position in which the supports are substantially parallel to one another and use position in which the supports are co-linear. In accordance with some embodiments a locking element such as a pin or sliding lock over the pivot adjoining the portions may be provided to prevent first folding bar 127 from moving from the use to the stored position and/or to provide stability.

Second front support leg 121 and second rear support leg 126 are connected by second folding bar 128. Second folding bar 128 is made of two portions. Each of the portions of second folding bar 128 has a first end connected to one of second front support leg 121 or second rear support leg 126 by a pivot; and the second ends of the portions are connected by a pivot or a hinge to allow the portions of the folding bar to move between a stored position in which the supports are substantially parallel to one another and use position in which the supports are co-linear. In accordance with some embodiments a locking element such as a pin or sliding lock over the pivot adjoining the portions may be provided to prevent second folding bar 128 from moving from the use to the stored position and/or to provide stability.

Brace 197 is a support that extends between first front support leg 120 and second front support leg 121. In the shown embodiment, brace 197 is a u-shaped bar with ends that are substantially parallel to first and second front support legs 120 and 121; and a middle portion that is substantially perpendicular to first and second front legs 120 and 121. Each of the ends is fastened to one of first and second front legs 120 and 121 using bolts or any other conventional manner. Brace 197 provides stability by holding first front support leg 120 and second front support leg 121 apart.

To provide stability for first and second rear support legs 125 and 126, rollator 100 includes u-shaped bar 112. U-shaped bar 112 is arranged along a plane that is substantially parallel to the ground. U-shaped bar 112 has ends that extend outward from first and second rear support legs 125 and 126 towards first and second front support legs 120 and 121 and a middle portion connecting the two end portions. In the shown embodiment, the ends of u-shaped bar are of sufficient length to ensure that the middle portion does not cross in the support area between the four support legs.

In accordance with this invention a foldable seat is provided that may be attached to a walking device. A foldable seat designed in accordance with the invention provides better stability than prior art seats. Further, the seat folds from a stored position outside the area of support to a use position within the area of support provided by the walking device. Thus, a user may use the walking device for support while mounting the folding seat. Further, a foldable seat in accordance with this invention folds into the support area from an area in front of a user. Thus, the user may walk directly over the seat to mount the seat. Thus, eliminating the amount of movement needed. This is an advantage for the infirm or elderly that may have a limited range of movement.

In the shown embodiment, foldable seat 150 is a foldable seat in accordance with this invention. Foldable seat 150 includes seat 160. A bottom surface of seat 160 is mounted on base 170. Seat 160 may be affixed to base 170 by bolts, epoxy or any other manner. The exact method by which seat 160 is affixed is not important to the invention. Base 170 includes a platform and substantially triangular piece that extends downward from the bottom surface of the platform the seat is affixed to the top surface of the platform. Preferably, seat 150 includes padding for the comfort of the user. Although, unpadded seats may be used without departing from this invention.

Leg 165 is rigidly affixed to the bottom of seat 160. In the shown embodiment, leg 165 is affixed to base 170. However, one skilled in the art will recognize that leg 165 may be affixed directly to the bottom surface of seat 160 and the exact configuration is left to those skilled in the art. For purposes of this discussion, rigidly affixed means that leg 165 is connected securely to the bottom surface of seat 160 such that the movement of leg 165 with respect to the chair is limited and/or prevented. By rigidly affixing leg 165 to the bottom surface of seat 160, a foldable chair provides greater stability as leg 165 does not move with respect to the rest of foldable seat 160. Thus, the user does not have to fold leg 165 in position risking an improper configuration of the leg that may lead to instability.

In the shown embodiment, leg 165 extends downward at substantially a perpendicular angle from the bottom surface of the seat. However, the exact angle is not important as long as a bottom end of leg 165 can rest upon a surface when seat 150 is in the use position. In the shown embodiment, the bottom end of leg 165 branch into three separate feet 175-177. Feet 175-177 form a triangular base to provide more stable support for seat 160. However, any number of feet and any pedestal design may be used without departing from this invention. The top end leg 165 is affixed to base 170 by a nut and bolt in the shown embodiment. However, other means for attaching including, but not limited to, means such as welding, epoxy, or threaded opening may be used without departing from this invention.

As leg 165 is rigidly affixed to the bottom surface of seat 160, foldable seat 150 must be configured such that seat 160 and leg 165 are moved to a stored position that is outside of the support area provided by the walking aid. Foldable seat 150 is designed such that seat 160 and leg 165 are moved to a position that does not impede movement of a user in the support area. As such, foldable seat 150 is affixed to a support of the walking aid by a mounting clamp. In the shown embodiment, mounting clamp 192 couples to brace 197 between first and second front support legs 120 and 121. Mounting clamp 192 may be coupled in any fashion as long mounting clamp 192 is secured in place. To allow foldable seat to move between the stored and use positions, mounting clamp is connected to seat 160 by first and second moving bars 185 and 186. A first end of each of first and second mounting bars 185 and 186 is pivotally connected to mounting clamp 192. A second end of each of first and second mounting bars is pivotally connected to seat 160. The pivots allow first and second mounting bars to move from a use position in which each of the moving bars is substantially parallel to the ground to a stored position in which each of the moving bars are substantially perpendicular to the ground. Preferably, first and second moving bars 185 and 186 are configured such that first and second moving bars 185 and 186 are co-planar in a plane that is perpendicular to the ground.

In the shown embodiment, first moving bar 185 is connected to base 170 proximate the bottom surface of seat 160. Second moving bar 186 is connected underneath first moving bar 185 between first moving bar 185 and the ground. In order to facilitate pivoting between the use and stored positions, the connected pivots on mounting clamp 192 and base 170 are diagonal to one another. In this arrangement, pivot of first moving bar 185 is closer to a first end of the seat and the pivot for the second moving bar 186 is closer to the center of base 170. On mounting clamp 192, the pivot for second moving bar 186 is closer to seat 160 and the pivot for first mounting bar 185 is more distal from seat 160. This allows the moving bars to keep. seat 160 substantially perpendicular to the ground as seat 160 moves from the stored position to the use position. Alternatively, first mounting bar 185 may be shorter in length than second mounting bar 186 to achieve the same effect.

In accordance with some embodiments, a resistance device, such as spring 190, may be mounted between mounting clamp 192 and a point on one of first and second moving bars 185 and 186. The resistance device means provides constant resistance as a user moves foldable seat 150 between the stored and use position. Other types of resistance means including, but not limited to, disk springs may be used without departing from this invention. Furthermore, a locking means such as a c-clap, Velcro strap, or magnet may be mounted on leg 165 and/or one of first and second moving bars 185 and 186 to secure leg 165 to the moving bars to hold foldable seat 150 in the stored position.

In accordance with some embodiments of this invention, basket 196 may be affixed to brace 197. Basket 196 is on a side of brace 197 that is opposite of the support area inside rollator 100. In further embodiments, table 195 or other surface may also be affixed to either brace 197 or basket 196. For user convenience, the table may be connected by a hinge or other type of pivot to allow table 195 to be moved when not in use.

The above is, a description of embodiments of a walking aid with a foldable seat in accordance with this invention. Those skilled in the art can and will design alternatives that infringe upon this invention as set forth in the following claims.

What is claimed is:

1. A foldable seat for attaching to a walking aid device comprising:
a seat having a top and bottom surface wherein said top surface provides a seating area;
a leg rigidly affixed to said bottom surface of said seat wherein said leg extends downward substantially perpendicularly from said bottom surface seat;
a mounting clamp affixable to a support of said walking aid device wherein said support is substantially parallel with the ground;
a first moving bar having a first end pivotally connected to said seat proximate a first end of said bottom surface and a second end pivotally connected to said mounting clamp; and
a second moving bar having a first end pivotally connected to said seat proximate a first end of said bottom surface and a second end pivotally connected to said mounting clamp such that said second moving bar is co-planar and parallel with said first moving bar and is situated between said first moving bar and the ground such that said first moving bar and said second moving bar are configured to pivot to move said seat from a first position in which an end of said leg is in contact with the ground to a second position in which said leg is substantially parallel with said first and second moving bars while keeping said seat substantially parallel to the ground.

2. The foldable seat of claim 1 wherein said second moving bar is the same length as said first moving bar.

3. The foldable seat of claim 1 wherein pivots connecting said first ends of said first moving bar and said second moving bar to said seat are offset from one another.

4. The foldable seat of claim 1 wherein pivots connecting said second ends of said first moving bar and said second moving bars are offset from one another.

5. The foldable seat of claim 1 further comprising:
a locking mechanism that holds said leg substantially parallel with said first and second moving bars responsive to said seat being in said second position.

6. The foldable seat of claim 5 wherein said locking mechanism comprises:
a clip that secures said second moving bar to said leg.

7. The foldable seat of claim 5 wherein said locking mechanism comprises:
a magnet affixed to one of said second moving bar and said leg to cause a magnetic connection between said second moving bar and said leg responsive to said seat being in said second position.

8. The foldable seat of claim 1 further comprising:
a base affixed to a bottom surface of said seat wherein said leg is secured to said base and said second ends of first and second moving bars are pivotally affixed to said base.

9. The foldable seat of claim 1 further comprising:
a connector that allows said mounting clamp to be coupled and decoupled to said support of said walking aid device.

10. The foldable seat of claim 1 further comprising:
resistance means for providing constant resistance as said seat is moved between said first and second position.

11. The foldable seat of claim 10 wherein said resistance means comprises:
a spring having a first end attached to said mounting clamp and a second end affixed to a point along one of said first and second moving bars wherein said spring is in a relaxed state in said first and second positions and is stretched during movement betweens said first and second positions.

12. The foldable seat of claim 10 wherein said resistance means comprises:
a first disk spring assembly which includes a bolt affixed to one end of the first moving bar to attach said moving bar to said mounting clamp and two groupings of one disk spring in-between two flat washers placed co-axially with said bolt sandwiching the moving bar to provide for constant resistance as the seat is moved between the first and second positions; and
a second disk spring assembly which includes a bolt affixed to one end of the second moving bar to attach said moving bar to said mounting clamp and two groupings of one disk spring in-between two flat washers placed co-axially with said bolt sandwiching the moving bar to provide constant resistance as the seat is moved between the first and second positions.

13. The foldable seat of claim 10 wherein said walking device includes four legs and u-bar having a first end that extends from a first rear leg of said walking device towards a first front leg, a second end that extends from a second rear leg towards a second front leg and a middle portion that extends between said first and second ends of said u-bar to provide an open area between said four legs.

14. The foldable seat of claim 1 further comprising:
a plurality of supports that extend from a bottom end of said leg to form a base to support said seat.

15. A walking aid device comprising:
four support legs including a first front support leg, a second front support leg, a first rear support leg and a second rear support leg wherein said four support legs are arranged to define a quadrilateral support area between said four support legs;
a first brace bar that extends between said first front support leg and said second front support leg; and
a foldable seat affixed to said first brace bar comprising:
a seat having a top and bottom surface wherein said top surface provides a seating area,
a leg rigidly affixed to said bottom surface of said seat wherein said leg extends downward substantially perpendicularly from said bottom surface seat,
a mounting clamp affixable to said first brace bar of said walking aid device,
a first moving bar having a first end pivotally connected to said seat proximate a first end of said bottom surface and a second end pivotally connected to said mounting clamp, and
a second moving bar having a first end pivotally connected to said seat proximate a first end of said bottom surface and a second end pivotally connected to said mounting clamp such that said second moving bar is co-planar and parallel with said first moving bar and is situated between said first moving bar and the ground such that said first moving bar and said second moving bar are configured to pivot to move said seat from a first position in which an end of said leg is in contact with the ground to a second position in which said leg is substantially parallel with said first and second moving bars while keeping said seat substantially parallel to the ground.

16. The walking aid device of claim 15 wherein said second moving bar is the same length as said first moving bar.

17. The walking aid device of claim 15 wherein pivots connecting said first ends of said first moving bar and said second moving bar to said seat are offset from one another.

18. The walking aid device of claim 15 wherein pivots connecting said second ends of said first moving bar and said second moving bars are offset from one another.

19. The walking aid device of claim 15 further comprising:
a u-shaped brace that connects said first rear support leg and said second rear support leg wherein said u-shaped brace comprises:
a first end that extends from said first rear support leg towards said first front support leg,
a second end that extends from said second rear support leg towards said second front support leg, and
a middle portion that extends between said first and second ends of said u-bar to provide an open area between said four support legs.

20. The walking aid device of claim 15 further comprising:
a first support handle that is affixed to a support between said first front support leg and said first rear support leg; and
a second support handle that is affixed to a support between said second front support leg and said second rear support leg.

21. The walking aid device of claim 20 wherein said first and second support handles are each substantially cylindrical and extend substantially perpendicular to said four support legs.

22. The walking aid device of claim 15 further comprising:
a table pivotally mounted to a support between said first front support leg and said second front support leg on an opposite side of said support from said support area.

23. The walking aid device of claim 22 further comprising:
a basket mounted to said support under said table.

24. The walking aid device of claim 15 further comprising:
a plurality of wheels affixed to a bottom end of said four support legs wherein at least one of said plurality of wheels is affixed to said first front support leg and said second front support leg.

25. The walking aid device of claim 15 wherein said foldable seat further comprises:
a locking mechanism that holds said leg substantially parallel with said first and second moving bars responsive to said seat being in said second position.

26. The walking aid device of claim 25 wherein said locking mechanism further comprises:
a clip that secures said second moving bar to said leg.

27. The foldable walking aid device of claim 25 wherein said locking mechanism further comprises:
a magnet affixed to one of said second moving bar and said leg to cause a magnetic connection between said second moving bar and said leg responsive to said seat being in said second position.

28. The walking aid device of claim 15 wherein said foldable seat further comprises:
a base affixed to a bottom surface of said seat wherein said leg is secured to said base and said second ends of first and second moving bars are pivotally affixed to said base.

29. The walking aid device of claim 15 wherein said foldable seat further comprises:
a connector that allows said mounting clamp to be coupled and decoupled to said support of said walking aid device.

30. The walking aid device of claim 15 wherein said foldable seat further comprises:
resistance means for providing constant resistance as said seat is moved between said first and second position.

31. The walking aid device of claim 30 wherein said resistance means comprises:
a spring having a first end attached to said mounting clamp and a second end affixed to a point along one of said first and second moving bars wherein said spring is in a relaxed state in said first and second positions and is stretched during movement between said first and second positions.

32. The foldable seat of claim 30 wherein said resistance means comprises:
a first disk spring assembly which includes a bolt affixed to one end of the first moving bar to attach said moving bar to said mounting clamp and two groupings of one disk spring in-between two flat washers placed co-axially with said bolt sandwiching the moving bar to provide for constant resistance as the seat is moved between the first and second positions; and
a second disk spring assembly which includes a bolt affixed to one end of the second moving bar to attach said moving bar to said mounting clamp and two groupings of one disk spring in-between two flat washers placed co-axially with said bolt sandwiching the moving bar to provide constant resistance as the seat is moved between the first and second positions.

33. The walking aid device of claim 15 wherein said foldable seat further comprises:
a plurality of supports that extend from a bottom end of said leg to form a base to support said seat.
